(19) United States
(12) Patent Application Publication
(10) Pub. No.: US 2010/0054258 A1
(43) Pub. Date: Mar. 4, 2010

(54) SWITCH, OPERATION METHOD THEREOF AND METHOD FOR UPDATING FORWARDING TABLE

(75) Inventor: Chia-Chieh Wu, Hsinchu City (TW)

Correspondence Address: J C PATENTS, 4 VENTURE, SUITE 250, IRVINE, CA, 92618, US

(73) Assignee: IC PLUS CORP., Hsin-Chu (TW)

(21) Appl. No.: 12/259,842

(22) Filed: Oct. 28, 2008

(30) Foreign Application Priority Data
Sep. 2, 2008 (TW) 97133629

(51) Int. Cl. H04L 12/56

(52) U.S. Cl. 370/395.31

(57) ABSTRACT

A switch, an operation method thereof, and a method for updating a forwarding table thereof are provided. The method for updating the forwarding table includes receiving a packet, and determining whether the packet is one of a Join type packet and a Leave type packet for determining to adopt a first VLAN table or a second VLAN table. In the first VLAN table, a first apparatus and a second apparatus are defined in different VLANs, and in the second VLAN table, the first apparatus and the second apparatus are defined in a same VLAN. When it is determined that the packet is one of the Join type packet and the Leave type packet, the second VLAN table is adopted for updating the forwarding table for simplifying the content of the forwarding table. Further, an efficiency of the switch can be improved by using the updated forwarding table.

### CROSS-REFERENCE TO RELATED APPLICATION

This application claims the priority benefit of Taiwan application serial no. 97133629, filed on Sep. 2, 2008. The entirety of the above-mentioned patent application is hereby incorporated by reference herein and made a part of this specification.

### BACKGROUND OF THE INVENTION

1. Field of the Invention

The present invention generally relates to a network switch, and more particularly, to a technology of forwarding a multicast packet.

2. Description of Related Art

Currently, network technologies are being drastically developed, and networks have been widely used. Generally, an Ethernet switch (switch hereinafter) is usually a very important element or even a necessary one for constructing a local area network (LAN). Typically, a current switch often has a function of virtual local area network (VLAN). The related specification of VLAN can be learnt by referring to IEEE 802.1Q.

Further, the current IP multicast technical specification mostly adopts the internet group management protocol (IGMP). The IGMP is mainly applied for forwarding multicast data between hosts of a LAN and a router. According to an operation mechanism of the IGMP, the hosts of the LAN are allowed to dynamically join (i.e., report to) or leave a multicast group. In this case, the Ethernet switch can be employed in the LAN for switching and forwarding packets within the LAN.

Some of current switches are further developed for supporting an IGMP snooping function, and therefore they can be used for snooping IGMP packets transmitted between the hosts and the router. When the switch indirectly receives an IGMP Join type packet transmitted from a host, the switch adds the host into a multicast group data table. When the switch indirectly receives an IGMP Leave type packet transmitted from a host, the switch deletes the host from the multicast group data table. The multicast group data is recorded in a forwarding table of the switch. Then, the switch transmits Multicast type packets in the LAN according to the forwarding table. Technologies of conventional switches for transmitting multicast data in different VLANs are to be discussed in more details herebelow.

FIG. 1 is a schematic diagram illustrating a conventional switch. Referring to FIG. 1, it shows a switch 10 including ports 101 through 105. The port 101 is electrically connected to an internet 201. The ports 102 through 105 are electrically connected to apparatuses 202 through 205 respectively. The apparatuses 202 through 205 are hosts. As shown in FIG. 1, it is assumed that the apparatuses 202 and 203 are allocated to a first VLAN group, and the apparatuses 204 and 205 are allocated to a second VLAN group. A network administrator defines a VLAN table in the switch 10, for defining the two VLAN groups. Table 1, as set forth below, is the VLAN table in the switch 10, in which VID represents VLAN identification values.

TABLE 1
VLAN Table in the Switch 10

| VID | Member |
|---|---|
| 1 | Port 101, 102, 103 |
| 1 | Port 101, 104, 105 |

It can be learnt from Table 1, that the ports 101, 102, and 103 are defined as the first VLAN group, represented as VID 1, while the ports 101, 104, and 105 are defined as the second VLAN group, represented as VID 2. It should be noted that members of different VLAN groups cannot communicate one to another. Specifically, the apparatus 202 can communicate with the apparatus 203, however the apparatus 202 cannot communicate with the apparatus 204.

When intending to join a same multicast group, the apparatuses 202 and 204 execute the IGMP and transmit a packet so as to update the forwarding table of the switch 10. The method of updating the forwarding table is to be discussed in more details herebelow.

First, the apparatus 202 transmits a packet of joining the first multicast group (for example having an IP address of 224.0.1.0) via the port 102 to the switch 10. The switch 10 then looks up the VLAN table (i.e., Table 1) for a corresponding VID according to the packet provided by the apparatus 202. The multicast registration information thereof is then recorded in the forwarding table of the switch 10. The port 102 corresponds to the VID 1, and therefore the forwarding table of the switch 10 is updated as shown in Table 2-1 as below.

TABLE 2-1
Forwarding Table of the Switch 10

| Address | VID | Port Map |
|---|---|---|
| 224.0.1.0 | 1 | Port 102 |

Then, the apparatus 204 transmits a packet of joining the first multicast group via the port 104 to the switch 10. The switch 10 then looks up the VLAN table (i.e., Table 1) for a corresponding VID according to the packet provided by the apparatus 204. The multicast registration information thereof is then recorded in the forwarding table of the switch 10. The port 104 corresponds to the VID 2, and therefore the forwarding table of the switch 10 is updated as shown in Table 2-2 as below.

TABLE 2-2
Forwarding Table of the Switch 10

| Address | VID | Port Map |
|---|---|---|
| 224.0.1.0 | 1 | Port 102 |
| 224.0.1.0 | 2 | Port 104 |

Then, when receiving a packet of the first multicast group from the internet 201, the switch 10 looks up the VLAN table (i.e., Table 1) for a corresponding VID according to the port 101 connected thereto. In the VLAN table (i.e., Table 1), the port 101 corresponds to VID1 and VID2.

With respect to VID 1, the switch 10 will look up the forwarding table (i.e., table 2-2) and enquires whether there is an entry satisfying that the address of 224.0.1.0 and VID=1. Apparently, the first entry of the forwarding table (i.e., table 2-2) satisfies the above conditions, and thus the switch forwards the packet of the first multicast group provided from the internet 201 to the apparatus 202 via the port 102.

With respect to VID 2, the switch 10 will look up the forwarding table (i.e., table 2-2) and enquires whether there is an entry satisfies the address of 224.0.1.0 and VID=2. Apparently, the second entry of the forwarding table (i.e., table 2-2) satisfies the above conditions, and thus the switch forwards the packet of the first multicast group provided from the internet 201 to the apparatus 204 via the port 104.

It should be noted that when members of different VLANs join a same multicast group, the forwarding table will correspondingly generate a plurality of entries, which consume spaces. Further, when the switch 10 receives a packet of the multicast group provided from the internet 201, the switch has to look up the forwarding table for many times and copy the packet of the multicast group provided from the internet 201 for many times, for forwarding the packet to the members of the different VLANs. In this case, the efficiency of the switch will be disadvantageously and seriously affected. Further, when more VLANs are used, the aforementioned disadvantage becomes more serious.

### SUMMARY OF THE INVENTION

Accordingly, the present invention is directed to provide a switch and an operation method thereof, for improving an efficiency of the switch.

The present invention is further directed to provide a method for updating a forwarding table, for simplifying a content of the forwarding table.

The present invention provides a switch. The switch includes a memory unit, a receiver, a packet parser, a processing unit, and a transmitter. The memory unit includes a forwarding table, a first virtual local area network (VLAN) table, and a second VLAN table recorded therein. In the first VLAN table, a first apparatus and a second apparatus are defined in different VLANs. In the second VLAN table, the first apparatus and the second apparatus are defined in a same VLAN. The receiver is adapted for receiving a packet. The packet parser is coupled to the receiver for determining whether the received packet is one of a Join type packet, a Leave type packet, and a Multicast type packet. The processing unit is coupled to the memory unit and the packet parser. When it is determined that the received packet is one of the Join type packet and the Leave type packet, the processing unit adopts the second VLAN table for updating the forwarding table. When it is determined that the received packet is the Multicast type packet, the processing unit generates a transmitting command according to the second VLAN table, the forwarding table and the received packet. The transmitter is coupled to the processing unit, for transmitting the packet according the transmitting command.

According to an embodiment of the present invention, the first apparatus and the second apparatus for example are hosts.

Viewing from another point, the present invention further provides an operation method of a switch. The operation method includes receiving a packet, and determining whether the received packet is one of a Join type packet, a Leave type packet, and a Multicast type packet, for determining to adopt a first VLAN table or a second VLAN table. In the first VLAN table, a first apparatus and a second apparatus are defined in different VLANs, and in the second VLAN table, the first apparatus and the second apparatus are defined in a same VLAN. When it is determined that the received packet is the Join type packet or the Leave type packet, a forwarding table is updated according to the second VLAN table and the packet. When it is determined that the received packet is the Multicast type packet, the packet is transmitted according to the forwarding table and the second VLAN table.

According to an embodiment of the present invention, when it is determined that the packet is one of the Join type packet, the Leave type packet, and the Multicast type packet, the second VLAN table is adopted, and when it is determined that the packet is none of the Join type packet, the Leave type packet, and the Multicast type packet, the first VLAN table is adopted.

Viewing from a further point, the present invention provides an operation method of a switch. The operation method includes receiving a packet, and determining whether the received packet is one of a Join type packet, a Leave type packet, and a Multicast type packet, for determining to adopt a first VLAN table or a second VLAN table for updating a forwarding table or forwarding the packet. In the first VLAN table, a first apparatus and a second apparatus are defined in different VLANs, and in the second VLAN table, the first apparatus and the second apparatus are defined in a same VLAN. When it is determined that the packet is one of the Join type packet, the Leave type packet, and the Multicast type packet, the second VLAN table is adopted.

According to an embodiment of the present invention, when it is determined that the packet is none of the Join type packet, the Leave type packet, and the Multicast type packet, the first VLAN table is adopted.

Viewing from still another point, the present invention further provides a method for updating a forwarding table. The method includes receiving a packet, and determining whether the packet is one of a Join type packet and a Leave type packet for determining to adopt a first VLAN table or a second VLAN table. In the first VLAN table, a first apparatus and a second apparatus are defined in different VLANs, and in the second VLAN table, the first apparatus and the second apparatus are defined in a same VLAN. When it is determined that the packet is one of the Join type packet and the Leave type packet, the second VLAN table is adopted for updating the forwarding table.

According to an embodiment of the present invention, when it is determined that the packet is none of the Join type packet and the Leave type packet, the first VLAN table is adopted.

The present invention determines whether a received packet is one of a Join type packet and a Leave type packet, so as to determine to adopt a first VLAN table or a second VLAN table. In the first VLAN table, a first apparatus and a second apparatus are defined in different VLANs, and in the second VLAN table, the first apparatus and the second apparatus are defined in a same VLAN. When it is determined that the packet is one of the Join type packet and the Leave type packet, the second VLAN table is adopted for updating the forwarding table. Therefore, the present invention is adapted for simplifying the content of the forwarding table.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional switch.

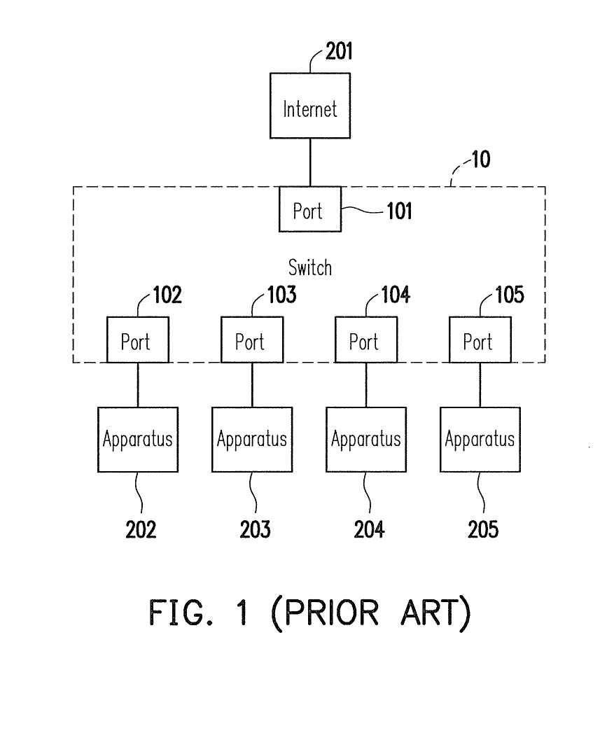

FIG. 2 is a schematic diagram illustrating a switch according to an embodiment of the present invention.

FIG. 3 is a flow chart illustrating an operation method of a switch according to an embodiment of the present invention.

### DESCRIPTION OF THE EMBODIMENTS

As discussed above, a conventional switch has only one VLAN table. As such, when members of different VLANs join to a same multicast group, not only entries of the forwarding table will sharply increase, but also the efficiency of the switch will be negatively affected.

Accordingly, in an embodiment of the present invention, the switch is defined as having two VLAN tables. In a first VLAN table, a first apparatus and a second apparatus are defined in different VLANs. In a second VLAN table, the first apparatus and the second apparatus are defined in a same VLAN. When the switch receives a packet, the switch determines whether the received packet is one of a Join type packet, a Leave type packet, and a Multicast type packet, so as to determine to adopt the first VLAN table or the second VLAN table. When it is determined that the received packet is one of the Join type packet, the Leave type packet, and the Multicast type packet, the second VLAN table can be adopted.

In other words, when the first apparatus and the second apparatus join a first multicast group, only one entry would be newly added to the forwarding table. Therefore, the content of the forwarding table is simplified. Further, when the switch receives a packet of the first multicast group from an internet, the switch will transmit the packet to the first apparatus and the second apparatus together. Therefore, the efficiency of the switch can be improved. Reference will now be made in detail to the present preferred embodiments of the invention, examples of which are illustrated in the accompanying drawings. Wherever possible, the same reference numbers are used in the drawings and the description to refer to the same or like parts.

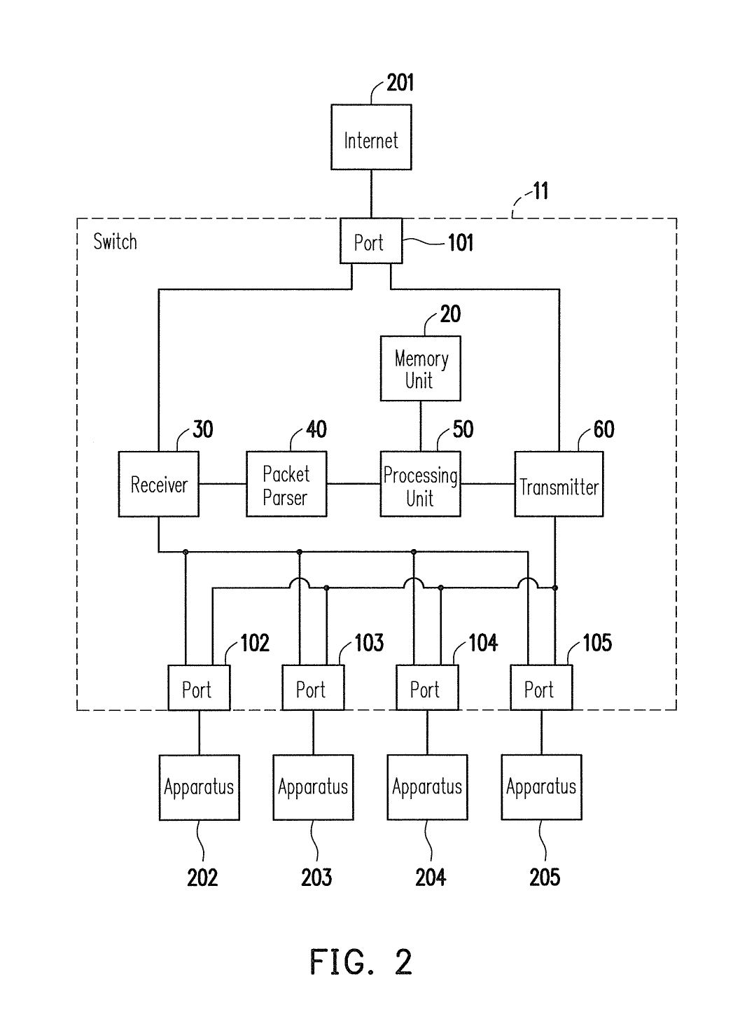

FIG. 2 is a schematic diagram illustrating a switch according to an embodiment of the present invention. Referring to FIG. 2, a switch 11 is shown. In the present embodiment, the switch 11 includes a memory unit 20, a receiver (RX) 30, a packet parser 40, a processing unit 50, and a transmitter (TX) 60. Further, the switch 11 may further include a plurality of ports. The present embodiment is exemplified as including 5 ports (i.e., 101 through 105). However, in other embodiments, the switch 11 may includes more or less ports which is not restricted by the present invention.

The port 101 is coupled to the internet 201, and the ports 102 through 105 are coupled to the apparatuses 202 through 205, respectively. In the present embodiment, the apparatuses 202 through 205 for example can be but is not restricted to be hosts. In other embodiments, the apparatuses 202 through 205 can also be other apparatuses, such as switches.

The receiver 30 is coupled to the ports 101 through 105 and the packet parser 40, for receiving a packet. The packet parser 40 is coupled to the processing unit 50, for parsing a type of the packet. The processing unit 50 is coupled to the memory unit 20 and the transmitter 60, for controlling the memory unit 20 and the transmitter 60. The transmitter 60 is coupled to the ports 101 through 105, for transmitting the packet. The memory unit 20 includes a forwarding table, a first VLAN table, and a second VLAN table recorded therein. In the present embodiment, it is assumed that the forwarding table, the first VLAN table, and the second VLAN table have initial statuses as listed in table 3-1, table 4, and table 5.

TABLE 3-1
Forwarding Table of Switch 11

| | | |
|---|---|---|
| Address | VID | Port Map |

TABLE 4
First VLAN Table

| VID | Member |
|---|---|
| 1 | Port 101, 102, 103 |
| 2 | Port 101, 104, 105 |

TABLE 5
Second VLAN Table

| VID | Member |
|---|---|
| 3 | Port 101, 102, 103, 104, 105 |

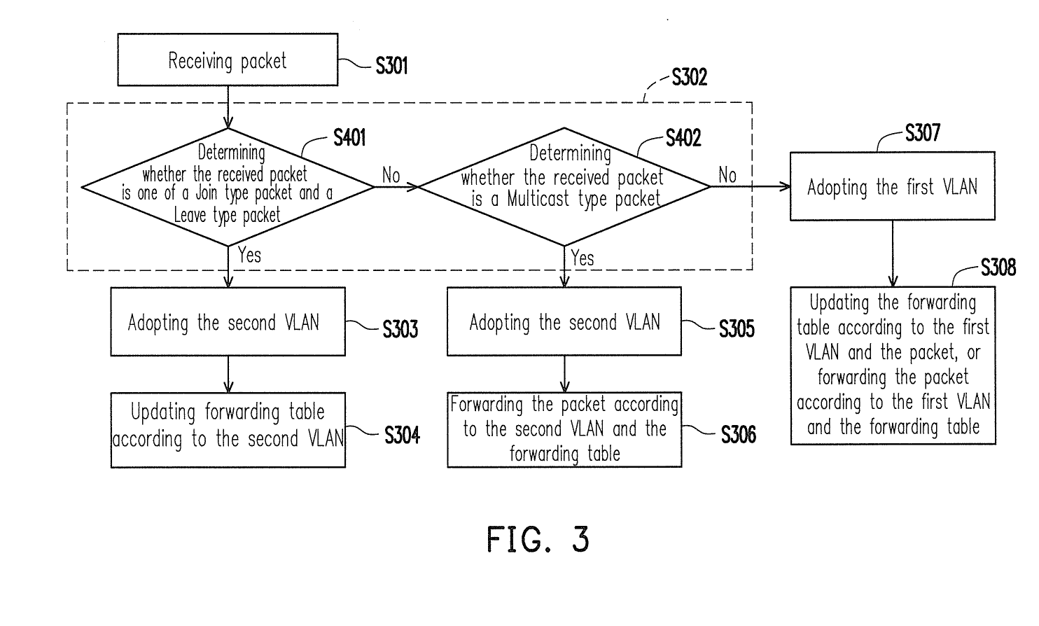

FIG. 3 is a flow chart illustrating an operation method of a switch according to an embodiment of the present invention. Referring to FIGS. 2 and 3 together, in the present embodiment, it is assumed that the apparatuses 202 and 204 are going to join the first multicast group (represented with IP=224.0.1.0).

### Join the Multicast Group

First, the apparatus 202 outputs a packet of joining the first multicast group via the port 102 to the switch 11. In other words, the switch 11 receives a Join type packet of the first multicast group provided from the apparatus 202, at step S301. Then, the packet parser 40 determines whether the packet is one of a Join type packet, a Leave type packet, and a Multicast type packet, at step S302, so as to determine to adopt the first VLAN table or the second VLAN table. If it is determined that the packet is one of the Join type packet, the Leave type packet, and the Multicast type packet, then, the second VLAN table is adopted; or otherwise, if it is determined that the packet is none of the Join type packet, the Leave type packet, and the Multicast type packet, then, the first VLAN table is adopted.

In the present embodiment, the step S302 for example includes steps S401 and S402. At step S401, the packet parser 40 determines whether the packet received at step S301 is one of the Join type packet and the Leave type packet. If it is, then the flow goes to step S303; or otherwise if it is not, then the flow goes to step S402. The packet provided by the apparatus 202 is the Join type packet of joining the first multicast group hereby, and therefore the flow goes to step S303, in which the second VLAN table is adopted.

After step S303, the flow goes to step S304, in which the processing unit 50 updates the forwarding table according to the second VLAN table and packet received at step S301. Specifically, the processing unit 50 looks up the second VLAN table for a corresponding VID according to the packet provided by the apparatus 202, and records a multicast registration data in the forwarding table of the memory unit 20. The port 102 corresponds to VID3, and therefore the forwarding table (Table 3-1) is going to be updated to Table 3-2 as below.

TABLE 3-2
Forwarding Table of Switch 11

| Address | VID | Port Map |
|---|---|---|
| 224.0.1.0 | 3 | Port 102 |

Similarly, the apparatus 204 can outputs a packet of joining the first multicast group via the port 104 to the switch 11, and correspondingly the present forwarding table (Table 3-2) is going to be updated to Table 3-3 as below.

TABLE 3-3
Forwarding Table of Switch 11

| Address | VID | Port Map |
|---|---|---|
| 224.0.1.0 | 3 | Port 102, 104 |

### Transmitting Multicast Type Packet

Then, it is assumed that the internet 201 outputs a packet of Multicasting the first multicast group via the port 101 to the switch 11. After the process from step S301 through step S401, the flow goes to step S402, in which the packet parser 40 determines whether the packet is the Multicast type packet. If it is, the flow goes to step S305; or otherwise if it is not, the flow goes to step S307. As it is assumed above, the packet provided by the internet 201 is the Multicast type packet, thus the flow goes to step S305, in which the second VLAN table is adopted.

Further, after step S305, the flow subsequently goes to step S306, in which received packet is forwarded according to the second VLAN table and the forwarding table. More specifically, the switch 11 will look up the second VLAN for a corresponding VID according to the port 101 coupled by the internet 201. In the second VLAN table, the port 101 corresponds to VID3. As such, the switch 11 enquires whether there is an entry in forwarding table (Table 3-3) satisfying that the address of 224.0.1.0 and VID=3. Apparently, the first entry of the forwarding table (Table 3-3) satisfies the above conditions, and therefore the switch 11 will transmit the packet of the first multicast group provided by the internet 201 to the apparatuses 202 and 204 via the ports 102 and 104.

### Communication Between Apparatuses 202 and 204

It is assumed that the apparatus is going to transmit a packet to the apparatus 204 via the switch 11. Because such a packet is none of the Join type packet, the Leave type packet, and the Multicast type packet, therefore after the steps S301, S401 and S402, the flow directly goes to step S307, in which the first VLAN table is adopted, and thus goes to step S308.

At step S308, the switch 11 updates the forwarding table according to the first VLAN table and the packet, or forwards the packet according to the first VLAN table and the forwarding table. In the present embodiment, the ports 102 and 104 which correspond to the apparatuses 202 and 204 are defined to different VLANs, and therefore the switch 11 will stop the apparatus 202 to transmit the packet to the apparatus 204. In other words, when the switch 11 receives a packet that is none of the Join type packet, the Leave type packet, and the Multicast type packet, the switch 11 is going to execute steps similar to those of the conventional technology as discussed above, so as to achieve similar advantages of the conventional.

### Leaving Multicast Group

It is assumed that the apparatus 202 is going to leave the first multicast group. First, the apparatus 202 outputs a packet of leaving the first multicast group to the switch 11 via the port 102. Then the flow sequentially processes the steps S301, S401, S303, and S304, so that the forwarding table (Table 3-3) will be updated to Table 3-4 as below.

TABLE 3-4
Forwarding Table of Switch 11

| Address | VID | Port Map |
|---|---|---|
| 224.0.1.0 | 3 | Port 104 |

Then, it is assumed that the apparatus 204 is going to leave the first multicast group. The apparatus 204 outputs a packet of leaving the first multicast group to the switch 11 via the port 102. Then the flow sequentially processes the steps S301, S401, S303, and S304, so that the forwarding table (Table 3-4) will be updated to Table 3-5 as below.

TABLE 3-5
Forwarding Table of Switch 11

| | | |
|---|---|---|
| Address | VID | Port Map |

The present embodiment is to be compared with the conventional technology, so as to show unexpectable advantages achieved by the present invention.

When the apparatuses 202 and 204 are going to join a same multicast group, the present embodiment adopts the second VLAN table in which the apparatuses 202 and 204 are defined in a same VLAN. As such, the content of the forwarding table can be effectively simplified (the forwarding table, Table 3-3, records only one entry). Comparatively, the forwarding table (Table 2-2) of the conventional technology records two entries. Apparently, the embodiment of the present invention is adapted to effectively simplify the content of the forwarding table, thus effectively saving space of the memory unit 20.

Further, when the switch 11 transmits the Multicast type packet provided by the internet 201, the embodiment of the present invention transmits the packet according to the second VLAN table and the forwarding table, and therefore is adapted to improve an efficiency of the switch 11. More specifically, with respect to the Multicast type packet provided by the internet 201, the second VLAN table of the embodiment of the present invention corresponds to one VID only, and therefore the Multicast type packet provide by the internet 201 can be transmitted to the apparatuses 202 and 204 together by looking up the forwarding table (Table 3-3) for only once. Comparatively, the conventional technology VLAN table corresponds to two VIDs. As such, the conventional technology must to look up the forwarding table (Table 2-2) for twice, and copy the Multicast type packet provided by the internet 201 for twice, for transmitting the packet to the apparatus 202 and 204. Apparently, the embodiment of the present invention is adapted for improving the efficiency of the switch 11.

Further, in the present embodiment, when the apparatus 202 is going to transmit a packet to the apparatus 204 via the switch 11, the switch 11 can adopt the first VLAN table, and stops the apparatus 202 from transmitting the packet to the apparatus 204. In other words, the switch 11 of the embodiment of the present invention maintains the advantages of the conventional VLAN function.

Although the foregoing embodiments have exemplified applicable statuses of the switch, the operation method of the switch, and the method for updating the forwarding table, those skilled in the art should understand that the switch, the operation method of the switch, and the method for updating the forwarding table may be varied or modified in accordance with different designs of different manufacturers. As such, the statuses are not restricted by the present invention. In other words, whenever it is determined that whether a packet is one of a Join type packet and a Leave type packet, for adopting a first VLAN table or a second VLAN table, it is construed as within the scope of the present invention. Several further embodiments are to be given below for allowing those skilled in the art to learn more about the spirit of the present invention.

In the foregoing embodiments, Table 4 and Table 5 are only one optional embodiment of the first VLAN table and the second VLAN table, without restricting the scope of the present invention. Those skilled in the art should be able to vary the members of the VLANs as desired.

Referring to FIG. 2 again, in the foregoing embodiments, although the tables are utilized to identify different VLANs according to the ports 101 through 105 of the switch 11, the present invention is not restricted as such. In other embodiments, those skilled in the art may also vary to use ports and protocols for identifying different VLANs (port-and-protocol-based VLAN), or use media access control (MAC) addresses for identifying different VLANs (MAC-address-based VLAN), or use subnets for identifying different VLANs (subnet-based VLAN). In such a way, similar functions can be achieved as the above embodiments.

Referring to FIGS. 2 and 3 together, the step S306 of the foregoing embodiment is only an optional embodiment. Those skilled in the art should be able to vary or modify the step S306 according to desired applications. For example, at step S306, the switch 11 can look up the second VLAN table for the corresponding VID according to the port 101 coupled to the internet 201. In the second VLAN table, the port 101 corresponds to VID3. As such, the switch 11 enquires whether there is an entry in forwarding table (Table 3-3) satisfying that the address of 224.0.1.0 and VID=3. Apparently, the first entry of the forwarding table (Table 3-3) satisfies the above conditions, and the port is mapped to ports 102 and 104. Then, the switch further checks whether the ports 102 and 104 are members of VID=3 in the second VLAN table. If they are, the switch 11 will transmit the packet of the first multicast group provided by the internet 201 to the apparatuses 202 and 204 via the ports 102 and 104; or otherwise they are not, then the switch 11 stops the transmission of the packet, so as to achieve a double confirmation of avoiding a transmission error.

In summary, the present invention determines whether a received packet is one of a Join type packet and a Leave type packet, so as to determine to adopt a first VLAN table or a second VLAN table. In the first VLAN table, a first apparatus and a second apparatus are defined in different VLANs, and in the second VLAN table, the first apparatus and the second apparatus are defined in a same VLAN. When it is determined that the packet is one of a Join type packet and a Leave type packet, the second VLAN table is adopted for updating the forwarding table. Therefore, the present invention is adapted for simplifying the content of the forwarding table. Further, the present embodiments includes at least the following advantages:
1. When the switch receives a Multicast type packet, the switch adopts the second VLAN table and transmits the packet according to the second VLAN table and the forwarding table, so as to improve the efficiency of the switch.
2. When the received packet is none of a Join type packet, a Leave type packet, and a Multicast type packet, the switch adopts the first VLAN table, so as to maintain advantages of the VLAN function of the conventional switch.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A switch, comprising:
a memory unit having a forwarding table, a first virtual local area network (VLAN) table, and a second VLAN table recorded therein, wherein in the first VLAN table, a first apparatus and a second apparatus are defined in different VLANs, and in the second VLAN table, the first apparatus and the second apparatus are defined in a same VLAN;
a receiver, for receiving a packet;
a packet parser, coupled to the receiver for determining whether the received packet is one of a Join type packet, a Leave type packet, and a Multicast type packet;
a processing unit, coupled to the memory unit and the packet parser, wherein when it is determined that the received packet is one of the Join type packet and the Leave type packet, the second VLAN table is adopted for updating the forwarding table, and when it is determined that the received packet is the Multicast type packet, a transmitting command is generated according to the second VLAN table, the forwarding table and the received packet; and
a transmitter, coupled to the processing unit, for transmitting the packet according the transmitting command.

2. An operation method of a switch, comprising:
receiving a packet;
determining whether the received packet is one of a Join type packet, a Leave type packet, and a Multicast type packet, for determining to adopt a first VLAN table or a second VLAN table, wherein in the first VLAN table, a first apparatus and a second apparatus are defined in different VLANs, and in the second VLAN table, the first apparatus and the second apparatus are defined in a same VLAN;
updating a forwarding table according to the second VLAN table and the packet, when it is determined that the packet is one of the Join type packet and the Leave type packet; and
transmitting the packet according to the forwarding table and the second VLAN table when it is determined that the packet is the Multicast type packet.

3. The operation method according to claim 2 further comprising:
adopting the second VLAN table, when it is determined that the packet is one of the Join type packet, the Leave type packet, and the Multicast type packet; and
adopting the first VLAN, when it is determined that the packet is none of the Join type packet, the Leave type packet, and the Multicast type packet.

4. An operation method of a switch, comprising:
receiving a packet;
determining whether the received packet is one of a Join type packet, a Leave type packet, and a Multicast type packet, for determining to adopt a first VLAN table or a second VLAN table for updating a forwarding table or forwarding the packet, wherein in the first VLAN table, a first apparatus and a second apparatus are defined in different VLANs, and in the second VLAN table, the first apparatus and the second apparatus are defined in a same VLAN;
adopting the second VLAN table, when it is determined that the packet is one of the Join type packet, the Leave type packet, and the Multicast type packet.

5. The operation method according to claim 1 further comprising:
adopting the first VLAN table, when it is determined that the packet is none of the Join type packet, the Leave type packet, and the Multicast type packet.

6. A method for updating a forwarding table, comprising:
receiving a packet;
determining whether the packet is one of a Join type packet and a Leave type packet, for determining to adopt a first VLAN table or a second VLAN table, wherein in the first VLAN table, a first apparatus and a second apparatus are defined in different VLANs, and in the second VLAN table, the first apparatus and the second apparatus are defined in a same VLAN; and
adopting the second VLAN table for updating the forwarding table, when it is determined that the packet is one of the Join type packet and the Leave type packet.

7. The method according to claim 6, further comprising:
adopting the first VLAN table, when it is determined that the packet is none of the Join type packet and the Leave type packet.
